(19) United States
(12) Patent Application Publication
(10) Pub. No.: US 2025/0274947 A1
(43) Pub. Date: Aug. 28, 2025

(54) CONTROL PROTOCOL FEEDBACK REPORT ENVELOPE

(71) Applicant: QUALCOMM Incorporated, San Diego, CA (US)

(72) Inventors: Jian LI, Shanghai (CN); Hao ZHANG, Shanghai (CN); Miao FU, Shanghai (CN); Pan JIANG, Shanghai (CN); Yan WANG, Shanghai (CN); Wei HE, Shanghai (CN)

(21) Appl. No.: 18/857,618

(22) PCT Filed: Jul. 8, 2022
(86) PCT No.: PCT/CN2022/104591

§ 371 Date: Oct. 17, 2024

(51) Int. Cl. H04W 72/231; H04L 5/00; H04W 4/14

(52) U.S. Cl. CPC H04W 72/231; H04L 5/0053; H04W 4/14

(57) ABSTRACT

Various aspects of the present disclosure generally relate to wireless communication. In some aspects. a user equipment (UE) may receive a downlink message at a modem of the UE. The UE may provide the downlink message from the modem to a circuit card. The UE may transmit. from the modem, relay protocol feedback for the downlink message based on a response from the circuit card. The UE may provide a control protocol (CP) feedback report envelope that indicates a CP feedback status. Numerous other aspects are described.

### FIELD OF THE DISCLOSURE

Aspects of the present disclosure generally relate to wireless communication and to techniques and apparatuses for reporting on control protocol feedback.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a downlink message at a modem of the UE. The method may include providing the downlink message from the modem to a circuit card. The method may include transmitting, from the modem, relay protocol (RP) feedback for the downlink message based on a response from the circuit card. The method may include providing a control protocol (CP) feedback report envelope that indicates a CP feedback status.

Some aspects described herein relate to a method of wireless communication performed by a circuit card. The method may include receiving a downlink message from a modem of a UE. The method may include providing a response for the downlink message to the modem. The method may include waiting for a CP feedback report envelope that indicates a CP feedback status. The method may include providing a proactive command based on the CP feedback status.

Some aspects described herein relate to a UE for wireless communication. The UE may include a memory, a modem, and one or more processors coupled to the memory. The one or more processors may be configured to receive a downlink message at a modem of the UE. The one or more processors may be configured to provide the downlink message from the modem to a circuit card. The one or more processors may be configured to transmit, from the modem, RP feedback for the downlink message based on a response from the circuit card. The one or more processors may be configured to provide a CP feedback report envelope that indicates a CP feedback status.

Some aspects described herein relate to a circuit card for wireless communication. The circuit card may include a memory and one or more processors coupled to the memory. The one or more processors may be configured to receive a downlink message from a modem of a UE. The one or more processors may be configured to provide a response for the downlink message to the modem. The one or more processors may be configured to wait for a CP feedback report envelope that indicates a CP feedback status. The one or more processors may be configured to provide a proactive command based on the CP feedback status.

Some aspects described herein relate to a non-transitory computer-readable medium that stores a set of instructions for wireless communication by a UE. The set of instructions, when executed by one or more processors of the UE, may cause the UE to receive a downlink message at a modem of the UE. The set of instructions, when executed by one or more processors of the UE, may cause the UE to provide the downlink message from the modem to a circuit card. The set of instructions, when executed by one or more processors of the UE, may cause the UE to transmit, from the modem, RP feedback for the downlink message based on a response from the circuit card. The set of instructions, when executed by one or more processors of the UE, may cause the UE to provide a CP feedback report envelope that indicates a CP feedback status.

Some aspects described herein relate to a non-transitory computer-readable medium that stores a set of instructions for wireless communication by a circuit card. The set of instructions, when executed by one or more processors of the circuit card, may cause the circuit card to receive a downlink message from a modem of a UE. The set of instructions, when executed by one or more processors of the circuit card, may cause the circuit card to provide a response for the downlink message to the modem. The set of instructions, when executed by one or more processors of the circuit card, may cause the circuit card to wait for a CP feedback report envelope that indicates a CP feedback status. The set of instructions, when executed by one or more processors of the circuit card, may cause the circuit card to provide a proactive command based on the CP feedback status.

Some aspects described herein relate to an apparatus for wireless communication. The apparatus may include means for receiving a downlink message at a modem of the apparatus. The apparatus may include means for providing the downlink message from the modem to a circuit card coupled to the apparatus. The apparatus may include means for transmitting, from the modem, RP feedback for the downlink message based on a response from the circuit card. The apparatus may include means for providing a CP feedback report envelope that indicates a CP feedback status.

Some aspects described herein relate to an apparatus for wireless communication. The apparatus may include means for receiving a downlink message from a modem of a UE. The apparatus may include means for providing a response for the downlink message to the modem. The apparatus may include means for waiting for a CP feedback report envelope that indicates a CP feedback status. The apparatus may include means for providing a proactive command based on the CP feedback status.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example associated with messaging, in accordance with the present disclosure.

FIG. 5 is a diagram illustrating an example associated with messaging, in accordance with the present disclosure.

FIG. 6 is a diagram illustrating an example of using a control protocol reporting envelope for messaging, in accordance with the present disclosure.

FIG. 7 is a diagram illustrating an example process performed, for example, by a UE, in accordance with the present disclosure.

FIG. 8 is a diagram illustrating an example process performed, for example, by a circuit card, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

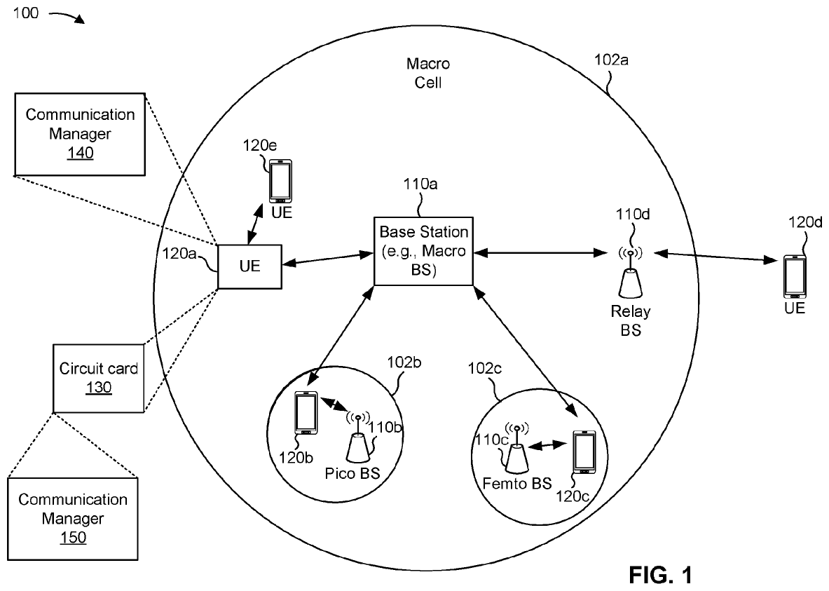

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller may couple to or communicate with a set of network entities and may provide coordination and control for these network entities. The network controller may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a downlink message at a modem of the UE and provide the downlink message from the modem to a circuit card. The communication manager 140 may transmit, from the modem, relay protocol (RP) feedback for the downlink message based on a response from the circuit card. The communication manager 140 may provide a control protocol (CP) feedback report envelope that indicates a CP feedback status. Additionally, or alternatively, the communication manager 140 may perform one or more other operations described herein.

In some aspects, a circuit card may include a communication manager 150. As described in more detail elsewhere herein, the communication manager 150 may receive a downlink message from a modem of a UE and provide a response for the downlink message to the modem. The communication manager 150 may wait for a CP feedback report envelope that indicates a CP feedback status and provide a proactive command based on the CP feedback status. Additionally, or alternatively, the communication manager 150 may perform one or more other operations described herein.

As indicated above, FIG. 1 is provided as an example. Other examples may differ from what is described with regard to FIG. 1.

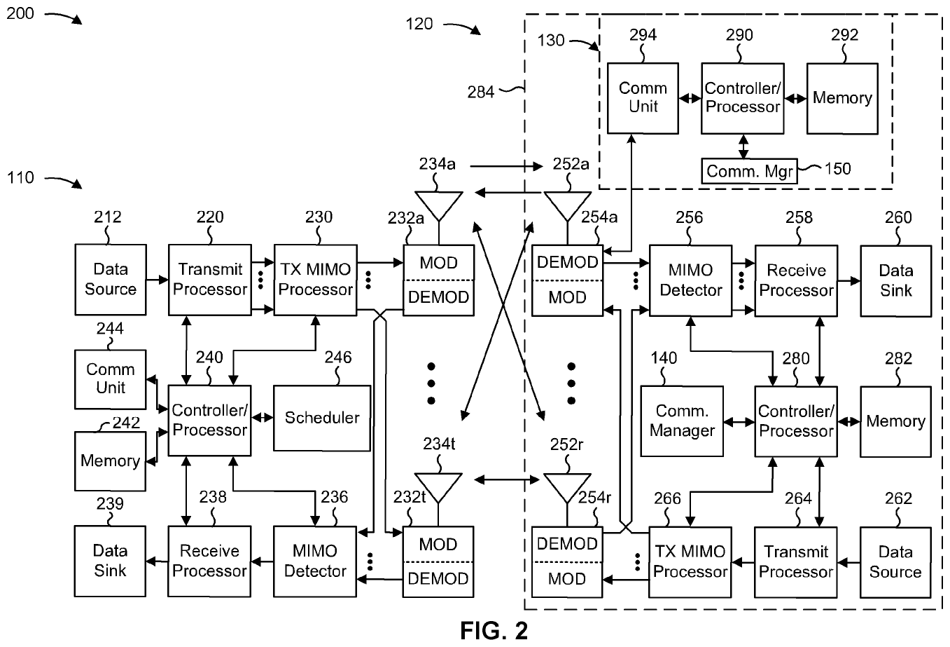

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

A circuit card 130 (e.g., universal integrated circuit card (UICC), smart card, subscriber identity module (SIM), or embedded SIM (eSIM)) may include a communication unit 294, a controller/processor 290, and a memory 292. The circuit card 130 may be inserted into or otherwise coupled to the UE 120. The circuit card 130 may communicate with a modem 254 of the UE 120 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

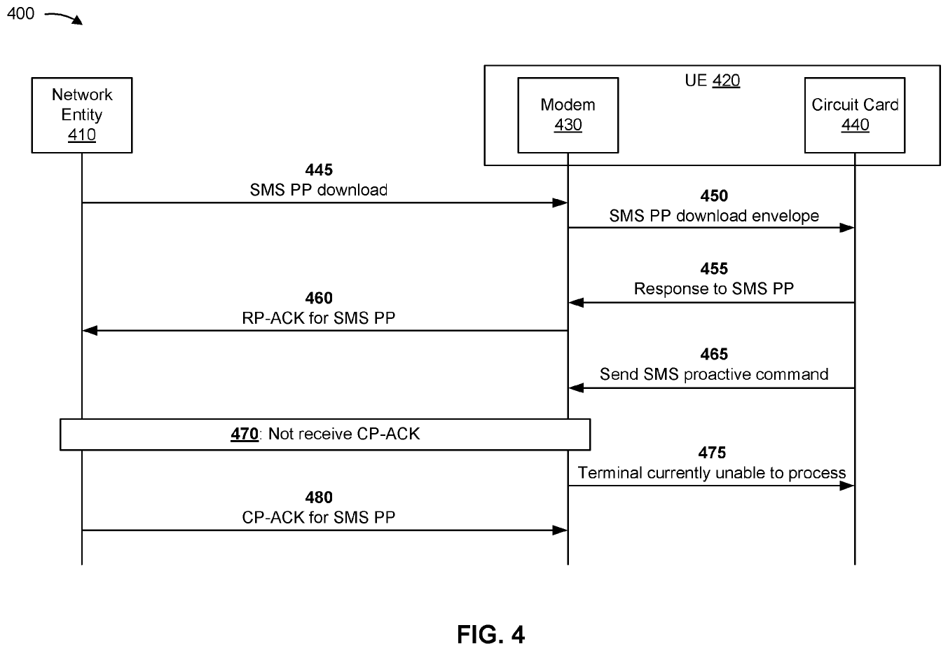

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

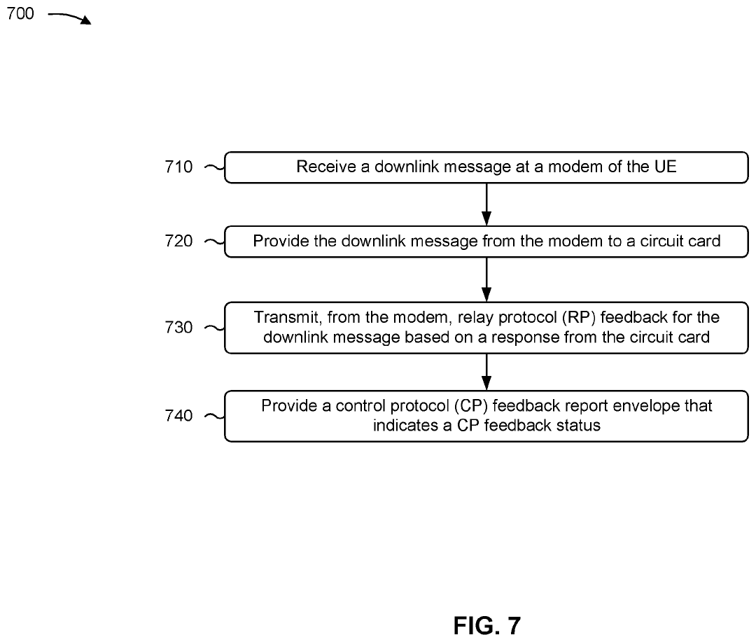

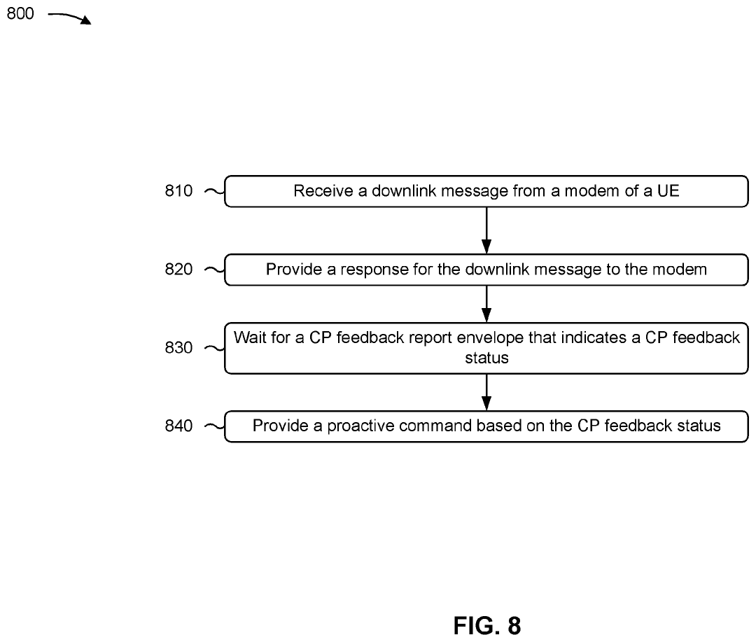

A controller/processor of a network entity (e.g., the controller/processor 240 of the base station 110), the controller/processor 280 of the UE 120, the controller/processor 290 of a circuit card (e.g., a circuit card 130), and/or any other component(s) of FIG. 2 may perform one or more techniques associated with reporting on CP feedback to the circuit card, as described in more detail elsewhere herein. For example, the controller/processor 240 of the base station 110, the controller/processor 280 of the UE 120, the controller/processor 290 of the circuit card, and/or any other component(s) of FIG. 2 may perform or direct operations of, for example, process 700 of FIG. 7, process 800 of FIG. 8, and/or other processes as described herein. The memory 242, the memory 282, and the memory 292 may store data and program codes for the network entity, the UE 120, and the circuit card, respectively. In some examples, the memory 242, the memory 282, and/or the memory 292 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity, the UE 120, and/or the circuit card may cause the one or more processors, the UE 120, the network entity, and/or the circuit card to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a downlink message at a modem of the UE; means for providing the downlink message from the modem to a circuit card; means for transmitting, from the modem, RP feedback for the downlink message based on a response from the circuit card; and/or means for providing a CP feedback report envelope that indicates a CP feedback status. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a circuit card (e.g., circuit card 130) includes means for receiving a downlink message from a modem of a UE; means for providing a response for the downlink message to the modem; means for waiting for a CP feedback report envelope that indicates a CP feedback status; and/or means for providing a proactive command based on the CP feedback status. In some aspects, the means for the circuit card to perform operations described herein may include, for example, one or more of communication manager 150, communication unit 294, controller/processor 290, memory 292.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258. and/or the TX MIMO processor 266 may be performed by or under the control of the controller/processor 280.

As indicated above, FIG. 2 is provided as an example. Other examples may differ from what is described with regard to FIG. 2.

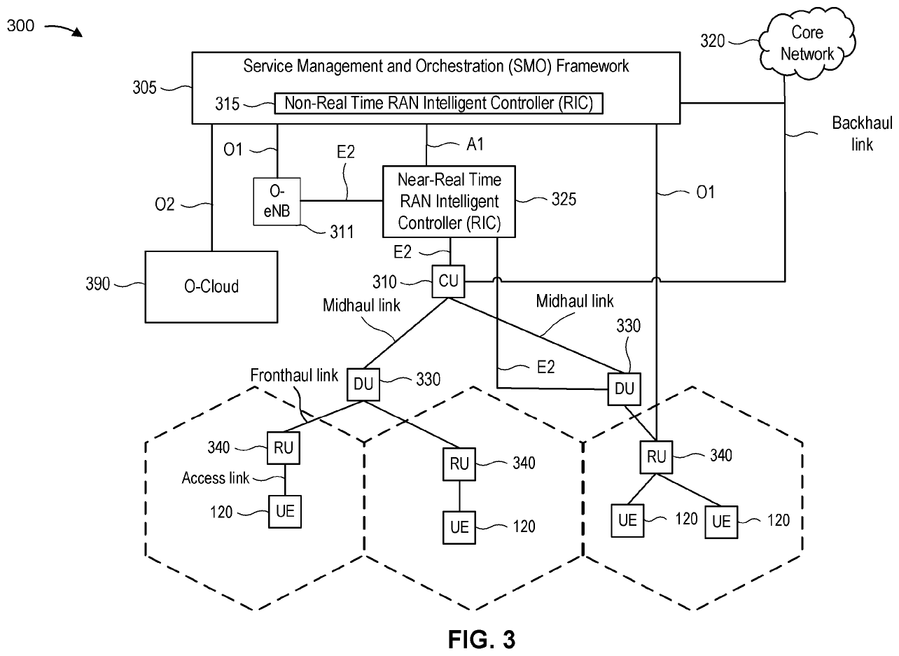

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUS 310, the DU's 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units Additionally, the units can include a wireless interface, which may include a receiver, a transmitter or transceiver (such as an RF transceiver). configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 associated with messaging, in accordance with the present disclosure. As shown in FIG. 4, a network entity 410 (e.g., base station 110) and a UE 420 (e.g., a UE 120) may communicate with one another via a modem 430 (e.g., modem 254). The UE 420 may be coupled to a circuit card 440 (e.g., a circuit card 130). For example, the circuit card 440 may be inserted into or embedded within the UE 420 and communicatively coupled to the modem 430. Accordingly, as used herein, a UE “coupled to” a circuit card includes a UE connected to a circuit card that is separate from the UE, or a UE having a circuit card internal to the UE.

The UE 420 may transmit and receive communications, such as text messages. The text messages may be short message service (SMS) messages. Signaling for the SMS messages may involve CP messages that are associated with a short message (SM) application layer and RP messages that are associated with an instant message (IM) layer.

The UE 420 may have an identity that is stored and provided by the circuit card 440 (e.g., SIM card, UICC). The modem 430 of the UE 420 may communicate with the circuit card 440 when transmitting SMS messages to and receiving SMS messages from network entity 410. If the UE 420 transmits an SMS message that is mobile originated (MO), the circuit card 440 may send an SMS proactive command to the modem 430. The SMS proactive command may provide an identity of the UE 420 for a transmission. The modem 430 may transmit an RP data message to the network entity 410. The modem 430 may notify the circuit card 440 through a terminal response after an RP acknowledgement (RP-ACK) or an RP-ERROR is received from the network entity 410.

If the UE 420 receives an SMS message that is mobile terminated (MT), the modem 430 may receive an SMS point-to-point (PP) download message, as shown by reference number 445. The modem 430 may forward the message to the circuit card 440 in an SMS PP download envelope, as shown by reference number 450. An envelope may be a message with fields (e.g., tag, length, device) that can be used for delivering data, an indication, and/or a status. As shown by reference number 455, the circuit card 440 may send a response to the SMS PP download. As shown by reference number 460, the modem 430 may transmit an RP-ACK for the SMS PP download message.

As shown by reference number 465, the circuit card 440 may send a proactive command, as part of an MO SMS message that follows the MT message. However, as shown by reference number 470, the modem 430 may not have received a CP-ACK, which is feedback for the RP-ACK. Therefore, the modem 430 is not able to process the proactive command for the subsequent MO SMS message. This is because the modem 430 cannot proceed to the MO SMS message without receiving a CP-ACK associated with the preceding MT SMS message. As shown by reference number 475, the modem 430 may send a message, such as a transmission response (TR), to the circuit card 440 that indicates that the modem 430 is unable to process the proactive command.

As shown by reference number 480, the modem 430 may receive the CP-ACK, but it is too late and the MO SMS message has failed. The circuit card 440 may have to request that the modem 430 fetch an MO SMS proactive command as soon as possible. The circuit card 440 may retry the MO SMS message but subsequent transactions between the network entity 410 and the circuit card 440 may be blocked due to such timing issues. In other words, the circuit card 440 cannot determine whether or when the CP-ACK will be received at the modem 430, and such a lack of synchronization causes messaging failures.

As indicated above, FIG. 4 is provided as an example. Other examples may differ from what is described with respect to FIG. 4.

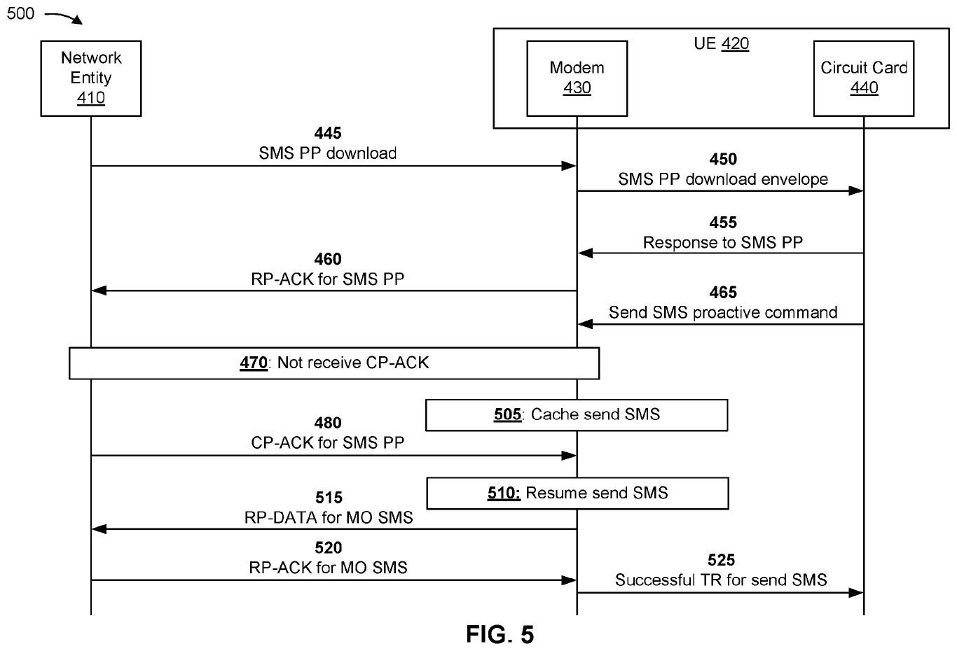

FIG. 5 is a diagram illustrating an example 500 associated with messaging, in accordance with the present disclosure.

One existing solution for issues related to the CP-ACK involves caching any proactive commands for an MO SMS message until the CP-ACK is received. For example, as shown by reference number 505, the modem 430 may cache the SMS proactive command for the MO SMS message that was sent by the circuit card 440 As shown by reference number 510, the modem 430 may resume transmission of the SMS message when the CP-ACK is received from the network entity 410. This may include transmitting RP data for the MO SMS message, as shown by reference number 515. As shown by reference number 520, the modem 430 may receive an RP-ACK for the MO SMS message. As shown by reference number 525, the modem 430 may transmit a successful TR for the MO SMS message that was sent by the circuit card 440. However, the modem 430 and the circuit card 440 are still not synchronized with each another. This may continue to be an issue for an MT SMS message that is triggered by the circuit card 440.

As indicated above, FIG. 5 is provided as an example. Other examples may differ from what is described with regard to FIG. 5.

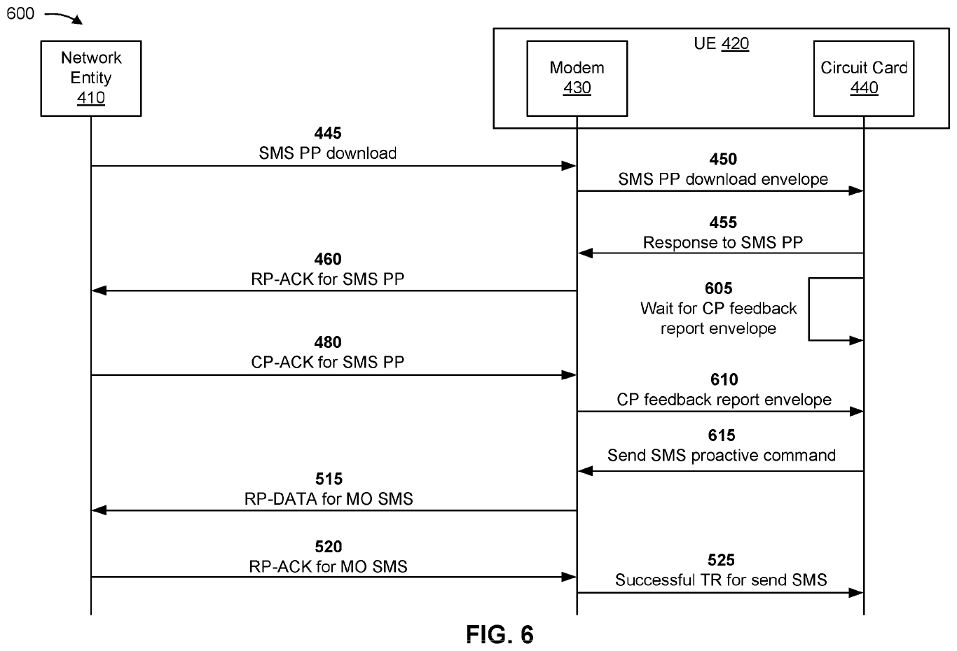

FIG. 6 is a diagram illustrating an example 600 of using a CP reporting envelope for messaging, in accordance with the present disclosure.

According to various aspects described herein, the circuit card 440 may wait for a CP feedback reporting envelope from the modem 430 before sending any SMS proactive commands. The circuit card 440 may expect the CP feedback report envelope at a reliable time. The modem 430 of the UE 420 may use the CP feedback report envelope to inform the circuit card 440 regarding whether successful CP feedback (e.g., a CP-ACK) has been received. For example, the CP feedback report envelope may include a CP feedback status that indicates whether a CP-ACK has been received or has not been received. The CP feedback report envelope may include a tag (e.g., SMS-PP download ACK reporting tag) that identifies the CP feedback report envelope to be used for CP feedback reporting. The CP feedback report envelope may also indicate a length of the CP feedback status (e.g., 1 bit) and/or include a device identity. Fields in the CP feedback report envelope may be mandatory, optional, or conditional. Once the CP feedback status is received, the circuit card 440 may proceed with an SMS proactive command based on the CP feedback status (e.g., CP-ACK received). In this way, the modem 430 and the circuit card 440 are in synchronization and handle CP-ACK issues more effectively. There is no uncertainty about the CP-ACK that causes the failure of subsequent MO SMS messages.

Example 600 shows use of a CP feedback report envelope. After the response to the SMS PP download envelope is sent (reference number 455), the circuit card 440 may wait for a CP feedback report envelope, as shown by reference number 605. This includes refraining from transmitting an SMS proactive command Once a CP-ACK for the SMS is received (reference number 480), the modem 430 may transmit the CP feedback report envelope, as shown by reference number 610. The circuit card 440 may determine, from the CP feedback status, whether the CP-ACK was received. If the CP-ACK status indicates that the CP-ACK was received, the circuit card 440 may transmit the SMS proactive command, as shown by reference number 615. The procedure may continue with the modem 430 transmitting the RP data.

In some aspects, the CP feedback report envelope may include a CP feedback status that indicates that a CP-ACK was not received or that a CP negative acknowledgement (CP-NACK) was received. For example, if the circuit card 440 receives a negative CP-ACK status, the circuit card 440 may trigger a new proactive command that will notify the network entity 410 to resend an earlier SMS-PP download message. In some cases, the new proactive command may be triggered if the circuit card 440 does not receive a CP feedback report envelope within a specified time duration.

By informing the circuit card 440, the circuit card 440 may refrain from transmitting an SMS proactive command for an MO SMS message soon after an MT SMS message. After a period of time, the circuit card 440 may initiate a new MO SMS message. In any event, the circuit card 440 and the modem 430 are synchronized such that the circuit card 440 is not guessing, failing, and retrying.

The use of the CP feedback report envelope may improve the success rate for back-to-back MT/MO SMS messages between the circuit card 440 and the modem 430 with a simplified design for both the modem 430 and the circuit card 440. In contrast to existing solutions, the modem 430 is not using additional memory resources for a cache buffer, and the circuit card 440 is not wasting resources by sending an SMS proactive command that will fail.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120, UE 420) performs operations associated with using a CP feedback report envelope to inform the circuit card.

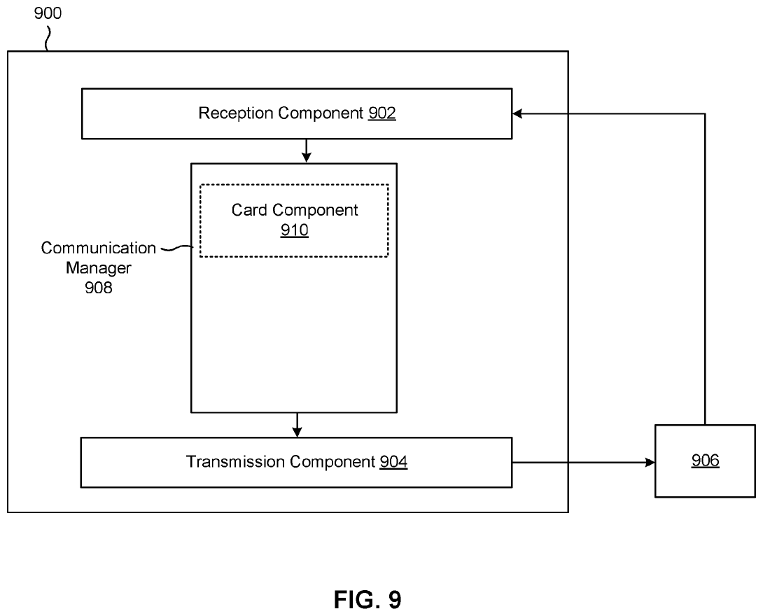

As shown in FIG. 7, in some aspects, process 700 may include receiving a downlink message at a modem (e.g., modem 430) of the UE (block 710). For example, the UE (e.g., using communication manager 908 and/or reception component 902 depicted in FIG. 9) may receive a downlink message at a modem of the UE, as described above.

As further shown in FIG. 7, in some aspects, process 700 may include providing the downlink message from the modem to a circuit card (block 720). For example, the UE (e.g., using communication manager 908 and/or card component 910 depicted in FIG. 9) may provide the downlink message from the modem to a circuit card, as described above.

As further shown in FIG. 7, in some aspects, process 700 may include transmitting, from the modem, RP feedback (e.g., an RP-ACK) for the downlink message based on a response from the circuit card (block 730). For example, the UE (e.g., using communication manager 908 and/or transmission component 904 depicted in FIG. 9) may transmit, from the modem, RP feedback for the downlink message based on a response from the circuit card, as described above.

As further shown in FIG. 7, in some aspects, process 700 may include providing a CP feedback report envelope that indicates a CP feedback status (block 740). For example, the UE (e.g., using communication manager 908 and/or card component 910 depicted in FIG. 9) may provide a CP feedback report envelope that indicates a CP feedback status, as described above.

Process 700 may include additional aspects, such as any single aspect or any combination of aspects described below and/or in connection with one or more other processes described elsewhere herein.

In a first aspect, the CP feedback report envelope includes a tag that indicates that the CP feedback report envelope is for CP feedback reporting.

In a second aspect, alone or in combination with the first aspect, the CP feedback report envelope includes one or more of a length value or a device identity.

In a third aspect, alone or in combination with one or more of the first and second aspects, the CP feedback status indicates an acknowledgement based on receiving a CP-ACK at the modem.

In a fourth aspect, alone or in combination with one or more of the first through third aspects, process 700 includes receiving, at the modem, a proactive command from the circuit card, and transmitting, from the modem, RP data based on the proactive command.

In a fifth aspect, alone or in combination with one or more of the first through fourth aspects, process 700 includes receiving, at the modem, an RP-ACK or an RP error.

In a sixth aspect, alone or in combination with one or more of the first through fifth aspects, process 700 includes providing, to the circuit card, feedback for the RP data.

In a seventh aspect, alone or in combination with one or more of the first through sixth aspects, the CP feedback status indicates a negative acknowledgement based on not receiving a CP-ACK.

In an eighth aspect, alone or in combination with one or more of the first through seventh aspects, process 700 includes receiving, at the modem, a proactive command from the circuit card, and transmitting, from the modem, RP data based on the proactive command.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a circuit card, in accordance with the present disclosure. Example process 800 is an example where the circuit card (e.g., a circuit card 130, circuit card 440) performs operations associated with receiving a CP feedback report envelope.

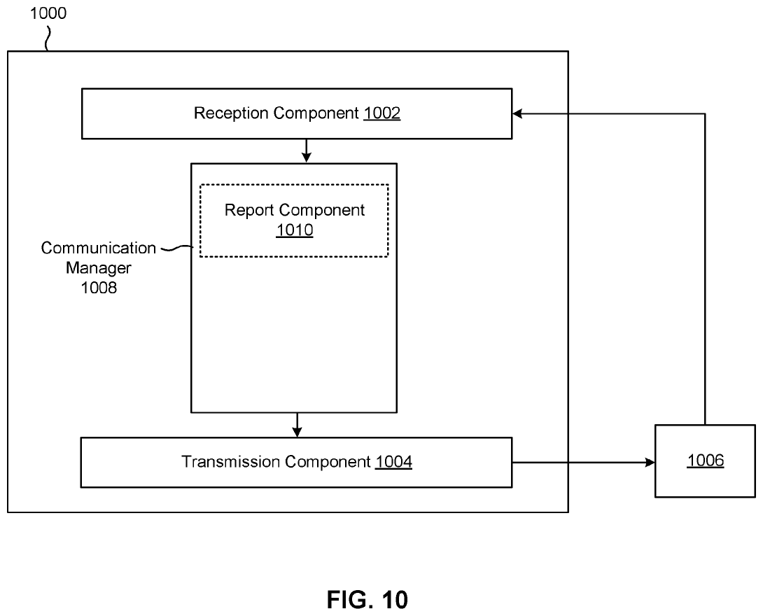

As shown in FIG. 8, in some aspects, process 800 may include receiving a downlink message from a modem of a UE (block 810). For example, the circuit card (e.g., using communication manager 1008 and/or reception component 1002 depicted in FIG. 10) may receive a downlink message from a modem of a UE, as described above.

As further shown in FIG. 8, in some aspects, process 800 may include providing a response for the downlink message to the modem (block 820). For example, the circuit card (e.g., using communication manager 1008 and/or transmission component 1004 depicted in FIG. 10) may provide a response for the downlink message to the modem, as described above.

As further shown in FIG. 8, in some aspects, process 800 may include waiting for a CP feedback report envelope that indicates a CP feedback status (block 830). For example, the circuit card (e.g., using communication manager 1008 and/or report component 1010 depicted in FIG. 10) may wait for a CP feedback report envelope that indicates a CP feedback status, as described above.

As further shown in FIG. 8, in some aspects, process 800 may include providing a proactive command based on the CP feedback status (block 840). For example, the circuit card (e.g., using communication manager 1008 and/or transmission component 1004 depicted in FIG. 10) may provide a proactive command based on the CP feedback status, as described above.

Process 800 may include additional aspects, such as any single aspect or any combination of aspects described below and/or in connection with one or more other processes described elsewhere herein.

In a first aspect, the circuit card is a UICC.

In a second aspect, alone or in combination with the first aspect, the circuit card is a physical SIM or an embedded SIM.

In a third aspect, alone or in combination with one or more of the first and second aspects, the CP feedback report envelope includes a tag that indicates that the CP feedback report envelope is for CP feedback reporting.

In a fourth aspect, alone or in combination with one or more of the first through third aspects, the CP feedback status indicates an acknowledgement.

In a fifth aspect, alone or in combination with one or more of the first through fourth aspects, process 800 includes transmitting a proactive command to the modem based on the CP feedback status indicating an acknowledgement (e.g., CP-ACK).

In a sixth aspect, alone or in combination with one or more of the first through fifth aspects, process 800 includes receiving, from the modem, feedback for an RP data transmission associated with the proactive command.

In a seventh aspect, alone or in combination with one or more of the first through sixth aspects, the CP feedback status indicates a negative acknowledgement (e.g., CP-NACK).

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., a UE 120, UE 420), or a UE may include the apparatus 900, such as a modem (e.g., modem 254, modem 430) of the UE. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown. the apparatus 900 may include the communication manager 908. The communication manager 908 may control and/or otherwise manage one or more operations of the reception component 902 and/or the transmission component 904. In some aspects, the communication manager 908 may include one or more antennas, a modem, a controller/processor, a memory, or a combination thereof, of the UE described in connection with FIG. 2. The communication manager 908 may be, or be similar to, the communication manager 140 depicted in FIGS. 1 and 2. For example, in some aspects, the communication manager 908 may be configured to perform one or more of the functions described as being performed by the communication manager 140. In some aspects, the communication manager 908 may include the reception component 902 and/or the transmission component 904. The communication manager 908 may include a card component 910, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a downlink message at a modem of the UE. The card component 910 may provide the downlink message from the modem to a circuit card. The transmission component 904 may transmit, from the modem, RP feedback for the downlink message based on a response from the circuit card. The card component 910 may provide a CP feedback report envelope that indicates a CP feedback status.

The reception component 902 may receive, at the modem, a proactive command from the circuit card. The transmission component 904 may transmit, from the modem, RP data based on the proactive command. The reception component 902 may receive, at the modem, an RP-ACK or an RP error.

The card component 910 may provide, to the circuit card, feedback for the RP data. The reception component 902 may receive, at the modem, a proactive command from the circuit card. The transmission component 904 may transmit, from the modem, RP data based on the proactive command.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a circuit card (e.g., a circuit card 130, circuit card 440), or a circuit card may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the network entity described in connection with FIG. 2. The communication manager 1008 may be, or be similar to, the communication manager 150 depicted in FIGS. 1 and 2. For example, in some aspects, the communication manager 1008 may be configured to perform one or more of the functions described as being performed by the communication manager 150. In some aspects, the communication manager 1008 may include the reception component 1002 and/or the transmission component 1004. The communication manager 1008 may include a report component 1010, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the circuit card described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering or decoding, among other examples), and may provide the processed signals to the one or more other components of the apparatus 1000. In some aspects, the reception component 1002 may include a receive processor, a controller/processor, a memory, or a combination thereof, of the circuit card described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, multiplexing, interleaving, mapping, or encoding, among other examples), and may transmit the processed signals to the apparatus 1006. In some aspects, the transmission component 1004 may include a transmit processor, a controller/processor, a memory, or a combination thereof, of the circuit card described in connection with FIG. 2. In some aspects, the transmission component 1004 may be co-located with the reception component 1002 in a transceiver.

The reception component 1002 may receive a downlink message from a modem of a UE. The transmission component 1004 may provide a response for the downlink message to the modem. The report component 1010 may wait for a CP feedback report envelope that indicates a CP feedback status. The transmission component 1004 may provide a proactive command based on the CP feedback status.

The transmission component 1004 may transmit a proactive command to the modem based on the CP feedback status indicating an acknowledgement. The reception component 1002 may receive, from the modem, feedback for an RP data transmission associated with the proactive command.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving a downlink message at a modem of the UE; providing the downlink message from the modem to a circuit card; transmitting, from the modem, relay protocol (RP) feedback for the downlink message based on a response from the circuit card; and providing a control protocol (CP) feedback report envelope that indicates a CP feedback status.

Aspect 2: The method of Aspect 1, wherein the CP feedback report envelope includes a tag that indicates that the CP feedback report envelope is for CP feedback reporting.

Aspect 3: The method of Aspect 1 or 2, wherein the CP feedback report envelope includes one or more of a length value or a device identity.

Aspect 4: The method of any of Aspects 1-3, wherein the CP feedback status indicates an acknowledgement based on receiving a CP acknowledgement (CP-ACK) at the modem.

Aspect 5: The method of Aspect 4, further comprising: receiving, at the modem, a proactive command from the circuit card; and transmitting, from the modem, RP data based on the proactive command.

Aspect 6: The method of Aspect 5, further comprising receiving, at the modem, an RP acknowledgement (RP-ACK) or an RP error.

Aspect 7: The method of Aspect 6, further comprising providing, to the circuit card, feedback for the RP data.

Aspect 8: The method of any of Aspects 1-3, wherein the CP feedback status indicates a negative acknowledgement based on not receiving a CP acknowledgement (CP-ACK).

Aspect 9: The method of Aspect 8, further comprising: receiving, at the modem, a proactive command from the circuit card; and transmitting, from the modem, RP data based on the proactive command.

Aspect 10: A method of wireless communication performed by a circuit card, comprising: receiving a downlink message from a modem of a user equipment (UE); providing a response for the downlink message to the modem; waiting for a control protocol (CP) feedback report envelope that indicates a CP feedback status; and providing a proactive command based on the CP feedback status.

Aspect 11: The method of Aspect 10, wherein the circuit card is a universal integrated circuit card.

Aspect 12: The method of Aspect 10 or 11, wherein the circuit card is a physical subscriber identity module (SIM) or an embedded SIM.

Aspect 13: The method of any of Aspects 10-12, wherein the CP feedback report envelope includes a tag that indicates that the CP feedback report envelope is for CP feedback reporting.

Aspect 14: The method of any of Aspects 10-13, wherein the CP feedback status indicates an acknowledgement.

Aspect 15: The method of Aspect 14, further comprising transmitting a proactive command to the modem based on the CP feedback status indicating an acknowledgement.

Aspect 16: The method of Aspect 15, further comprising receiving, from the modem, feedback for an RP data transmission associated with the proactive command.

Aspect 17: The method of any of Aspects 10-13, wherein the CP feedback status indicates a negative acknowledgement.

Aspect 18: An apparatus for wireless communication at a device, comprising a processor; memory coupled with the processor; and instructions stored in the memory and executable by the processor to cause the apparatus to perform the method of one or more of Aspects 1-17.

Aspect 19: A device for wireless communication, comprising a memory and one or more processors coupled to the memory, the one or more processors configured to perform the method of one or more of Aspects 1-17.

Aspect 20: An apparatus for wireless communication, comprising at least one means for performing the method of one or more of Aspects 1-17.

Aspect 21: A non-transitory computer-readable medium storing code for

wireless communication, the code comprising instructions executable by a processor to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold. less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory;
a modem; and
one or more processors, coupled to the memory, configured to:
receive a downlink message at the modem of the UE;
provide the downlink message from the modem to a circuit card;
transmit, from the modem, relay protocol (RP) feedback for the downlink message based on a response from the circuit card; and
provide a control protocol (CP) feedback report envelope that indicates a CP feedback status.

2. The UE of claim 1, wherein the CP feedback report envelope includes a tag that indicates that the CP feedback report envelope is for CP feedback reporting.

3. The UE of claim 1, wherein the CP feedback report envelope includes one or more of a length value or a device identity.

4. The UE of claim 1, wherein the CP feedback status indicates an acknowledgement based on receiving a CP acknowledgement (CP-ACK) at the modem.

5. The UE of claim 4, wherein the one or more processors are configured to:
receive, at the modem, a proactive command from the circuit card; and
transmit, from the modem, RP data based on the proactive command.

6. The UE of claim 5, wherein the one or more processors are configured to receive, at the modem, an RP acknowledgement (RP-ACK) or an RP error.

7. The UE of claim 6, wherein the one or more processors are configured to provide, to the circuit card, feedback for the RP data.

8. The UE of claim 1, wherein the CP feedback status indicates a negative acknowledgement based on not receiving a CP acknowledgement (CP-ACK).

9. The UE of claim 8, wherein the one or more processors are configured to:
receive, at the modem, a proactive command from the circuit card; and
transmit, from the modem, RP data based on the proactive command.

10. A circuit card for wireless communication, comprising:
a memory; and
one or more processors, coupled to the memory, configured to:
receive a downlink message from a modem of a user equipment (UE);
provide a response for the downlink message to the modem;
wait for a control protocol (CP) feedback report envelope that indicates a CP feedback status; and
provide a proactive command based on the CP feedback status.

11. The circuit card of claim 10, wherein the circuit card is a universal integrated circuit card.

12. The circuit card of claim 10, wherein the circuit card is a physical subscriber identity module (SIM) or an embedded SIM.

13. The circuit card of claim 10, wherein the CP feedback report envelope includes a tag that indicates that the CP feedback report envelope is for CP feedback reporting.

14. The circuit card of claim 10, wherein the CP feedback status indicates an acknowledgement.

15. The circuit card of claim 14, wherein the one or more processors are configured to transmit a proactive command to the modem based on the CP feedback status indicating an acknowledgement.

16. The circuit card of claim 15, wherein the one or more processors are configured to receive, from the modem, feedback for an RP data transmission associated with the proactive command.

17. The circuit card of claim 10, wherein the CP feedback status indicates a negative acknowledgement.

18. A method of wireless communication performed by a user equipment (UE), comprising:
receiving a downlink message at a modem of the UE;
providing the downlink message from the modem to a circuit card;
transmitting, from the modem, relay protocol (RP) feedback for the downlink message based on a response from the circuit card; and
providing a control protocol (CP) feedback report envelope that indicates a CP feedback status.

19. The method of claim 18, wherein the CP feedback report envelope includes a tag that indicates that the CP feedback report envelope is for CP feedback reporting.

20. The method of claim 18, wherein the CP feedback status indicates an acknowledgement based on receiving a CP acknowledgement (CP-ACK) at the modem.

21. The method of claim 20, further comprising:
receiving, at the modem, a proactive command from the circuit card; and
transmitting, from the modem, RP data based on the proactive command.

22. The method of claim 21, further comprising receiving, at the modem, an RP acknowledgement (RP-ACK) or an RP error.

23. The method of claim 22, further comprising providing, to the circuit card, feedback for the RP data.

24. The method of claim 18, wherein the CP feedback status indicates a negative acknowledgement based on not receiving a CP acknowledgement (CP-ACK).

25. A method of wireless communication performed by a circuit card, comprising:
receiving a downlink message from a modem of a user equipment (UE);
providing a response for the downlink message to the modem;
waiting for a control protocol (CP) feedback report envelope that indicates a CP feedback status; and
providing a proactive command based on the CP feedback status.

26. The method of claim 25, wherein the CP feedback report envelope includes a tag that indicates that the CP feedback report envelope is for CP feedback reporting.

27. The method of claim 25, wherein the CP feedback status indicates an acknowledgement.

28. The method of claim 27, further comprising transmitting a proactive command to the modem based on the CP feedback status indicating an acknowledgement.

29. The method of claim 28, further comprising receiving, from the modem, feedback for an RP data transmission associated with the proactive command.

30. The method of claim 25, wherein the CP feedback status indicates a negative acknowledgement.
